(19) United States
(12) Patent Application Publication
(10) Pub. No.: US 2009/0168381 A1
(43) Pub. Date: Jul. 2, 2009

(54) PRINTED WIRING BOARD UNIT AND METHOD OF MAKING THE SAME

(75) Inventor: Mitsuo SUEHIRO, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/206,971

(22) Filed: Sep. 9, 2008

(30) Foreign Application Priority Data
Dec. 28, 2007 (JP) 2007-339305

(51) Int. Cl. H01R 4/02; H01R 43/00

(52) U.S. Cl. 361/772; 29/854

(57) ABSTRACT

An electrically-conductive pin is inserted into a through hole penetrating through a substrate between a first surface and a second surface defined at the reverse side of the first surface so that the electrically-conductive pin stands upright from the first surface of the substrate. An electronic component is then mounted on the tip end of the electrically-conductive pin standing upright from the first surface. The electrically-conductive pin is inserted into the through hole before an electronic component is mounted on the tip end of the electrically-conductive pin. It is thus extremely easy to insert the electrically-conductive pin into the through hole. As compared with the case where the electrically-conductive pins are first bonded to an electronic component, an operator is released from a troublesome operation of inserting the electrically-conductive pin. The electronic component can be mounted in an efficient manner.

### BACKGROUND OF THE INVENTION

1. Field of the Invention

The present invention relates to a method of making a printed wiring board unit including a substrate and a surface mount device (SMD) mounted on the surface of the substrate.

2. Description of the Prior Art

An electronic component such as a power supply module includes a substrate, for example. Components such as a transistor, a capacitor, and the like, are mounted on the front and back surfaces of the substrate. Electrically-conductive pins such as lead terminals are attached to the substrate. The lead terminals stand upright from the back surface of the substrate, for example. The lead terminals are received in corresponding through holes formed in a printed wiring board of a motherboard, for example. The through holes are filled with solder. The through holes and the lead terminals are thus electrically connected to each other.

The lead terminals are inserted into the corresponding through holes so that the power supply module is mounted. The tip ends of the lead terminals protrude out of the corresponding through holes from the back surface of the printed wiring board.

The back surface of the printed wiring board is immersed in a molten solder in a solder bath. The capillary action inside the through hole allows the molten solder to penetrate into the through hole from the back surface of the printed wiring board. When the printed wiring board is taken out of the solder bath, the molten solder in the through holes is hardened or cured.

The power supply module is in this manner mounted on the front surface of the printed wiring board.

The lead terminals are arranged in a matrix at the back surface of the substrate of the power supply module, for example. It is required to accurately position the individual lead terminal to the corresponding through hole so that the power supply module is mounted. In the case where only one of the lead terminals bends, for example, such a lead terminal collides against the front surface of the printed wiring board. The lead terminal thus cannot be inserted into the corresponding through hole.

### SUMMARY OF THE INVENTION

It is accordingly an object of the present invention to provide a method, of making a printed wiring board unit, contributing to an efficient operation of mounting an electronic component. It is also an object of the present invention to provide a printed wiring board unit significantly contributing to realization of the method.

According to a first aspect of the present invention, there is provided a method of making a printed wiring board unit, comprising: inserting an electrically-conductive pin into a through hole penetrating through a substrate between a first surface and a second surface defined at the reverse side of the first surface so that the electrically-conductive pin stands upright from the first surface of the substrate; and mounting an electronic component on the tip end of the electrically-conductive pin standing upright from the first surface.

The method allows the electrically-conductive pin to be inserted into the through hole of the substrate. The electrically-conductive pin stands upright from the first surface of the substrate. An electronic component is then mounted on the tip end of the electrically-conductive pin. The electrically-conductive pin is inserted into the through hole before an electronic component is mounted on the tip end of the electrically-conductive pin. It is thus extremely easy to insert the electrically-conductive pin into the through hole. As compared with the case where the electrically-conductive pins are first bonded to an electronic component, an operator is released from a troublesome operation of inserting the electrically-conductive pin. The electronic component can be mounted in an efficient manner. In the method, a solder ball may be utilized to bond the electronic component to the tip end of the electrically-conductive pin.

In the method, the electrically-conductive pin may protrude out of the through hole from the second surface of the substrate when the electrically-conductive pin is inserted into the through hole. The method may further comprise immersing the second surface of the substrate in a molten solder in a solder bath.

When the substrate is immersed in a molten solder, the electrically-conductive pin is solely inserted in the through hole of the substrate. The heat capacity of the electrically-conductive pin is thus significantly smaller than the total heat capacity of the electrically-conductive pin and the electronic component. When heat is transferred to the electrically-conductive pin from the molten solder, heat tends to stay in the electrically-conductive pin. The temperature of the electrically-conductive pin can thus be kept sufficiently high. The molten solder is allowed to smoothly flow upward along the electrically-conductive pin. Even if the thickness of the substrate is set relatively large, the penetration of the molten solder into the through hole can reliably be achieved. The electrically-conductive pin is reliably bonded to the through hole through the solder.

According to a second aspect of the present invention, there is provided a printed wiring board unit comprising: a substrate defining a through hole penetrating through the substrate from a first surface to a second surface defined at the reverse side of the first surface; an electrically-conductive pin received in the through hole, the electrically-conductive pin standing upright from the first surface of the substrate; a solder received on the tip end of the electrically-conductive pin protruding from the first surface of the substrate; and an electronic component bonded to the tip end of the electrically-conductive pin through the solder.

The printed wiring board unit significantly contributes to realization of the aforementioned method. In addition, the solder is utilized to bond the electronic component to the tip end of the electrically-conductive pin. It is thus possible to remove the electronic component solely from the tip end of the electrically-conductive pin for replacement, for example. The electrically-conductive pin is kept bonded to the through hole. The process of replacing the electronic component is thus simplified.

The printed wiring board unit may further comprise a fillet formed at the tip end of the electrically-conductive pin, the tip end protruding out of the through hole from the second surface of the substrate. In this case, the electrically-conductive pin may include: a first pin body extending in the through hole; a second pin body connected to the tip end of the first pin body, the second pin body standing upright from the first surface of the substrate; and a stepped surface extending outward from the outer peripheral surface of the first pin body, the stepped surface received on the first surface of the substrate.

The electrically-conductive pin is received on the first surface of the substrate at the stepped surface. When the electrically-conductive pin is inserted, the electrically-conductive pin is reliably held on the substrate. The second pin body is allowed to stand upright from the first surface of the substrate. Simultaneously, the electrically-conductive pin is reliably prevented from sinking into the through hole and falling off the second surface of the substrate. The stepped surface may be defined on a flange protruding outward from the outer peripheral surface of the second pin body. Alternatively, the stepped surface may be defined on the second pin body having a second diameter larger than a first diameter of the first pin body.

In the printed wiring board unit, the electrically-conductive pin may include: a pin body having a constant diameter, the pin body protruding out of the through hole from the first surface of the substrate; and a coned portion formed at the tip end of the pin body, the coned portion expanding from the tip end of the pin body to a receiving surface for receiving the solder.

The printed wiring board unit allows the diameter of the coned portion to gradually increase as the position gets closer to the tip end of the pin body. The receiving surface having a relatively large diameter is thus defined at the tip end of the pin body. It is relatively easy to set solder on the receiving surface. In addition, when the solder is molten, the solder spreads over the side surface of the coned portion. This results in enhancement of the bonding strength between the electronic component and the electrically-conductive pin.

In the printed wiring board unit, the electrically-conductive pin may include: a press-fit portion elastically held in the through hole; and a pin body extending from the press-fit portion, the pin body standing upright from the first surface of the substrate. In the printed wiring board unit, the press-fit portion serves to keep the electrically-conductive pin in the through hole. Soldering is omitted from the process of coupling the electrically-conductive pin to the through hole.

### BRIEF DESCRIPTION OF THE DRAWINGS

The above and other objects, features and advantages of the present invention will become apparent from the following description of the preferred embodiments in conjunction with the accompanying drawings, wherein:

FIG. 1 is a perspective view schematically illustrating a server computer as an example of an electronic apparatus;

FIG. 2 is a perspective view schematically illustrating a main board unit as an example of a printed wiring board unit;

FIG. 3 is a partial sectional view, taken along the line 3-3 in FIG. 2, schematically illustrating a main board unit according to a first embodiment of the present invention;

FIG. 4 is a partial sectional view taken along the line 4-4 in FIG. 3;

FIG. 5 is partial sectional view schematically illustrating the process of inserting electrically-conductive pins into corresponding through holes formed in a printed wiring board;

FIG. 6 is a partial sectional view schematically illustrating the process of immersing the back surface of the printed wiring board in a molten solder in a solder bath;

FIG. 7 is a partial sectional view schematically illustrating the process of mounting a power supply module as an example of an electronic apparatus on the top ends of the electrically-conductive pins;

FIG. 8 is a partial sectional view schematically illustrating the process of mounting the power supply module on the top ends of the electrically-conductive pins;

FIG. 9 is a partial sectional view schematically illustrating the process of removing the power supply module from the top ends of the electrically-conductive pins;

FIG. 10 is a partial sectional view schematically illustrating the process of removing the power supply module from the top ends of the electrically-conductive pins;

FIG. 11 is a partial sectional view schematically illustrating a main board unit according to a modified embodiment;

FIG. 12 is a partial sectional view schematically illustrating a main board unit according to a second embodiment of the present invention; and

FIG. 13 is a partial sectional view schematically illustrating the process of inserting electrically-conductive pins into corresponding through holes formed in a printed wiring board.

### DESCRIPTION OF THE PREFERRED EMBODIMENTS

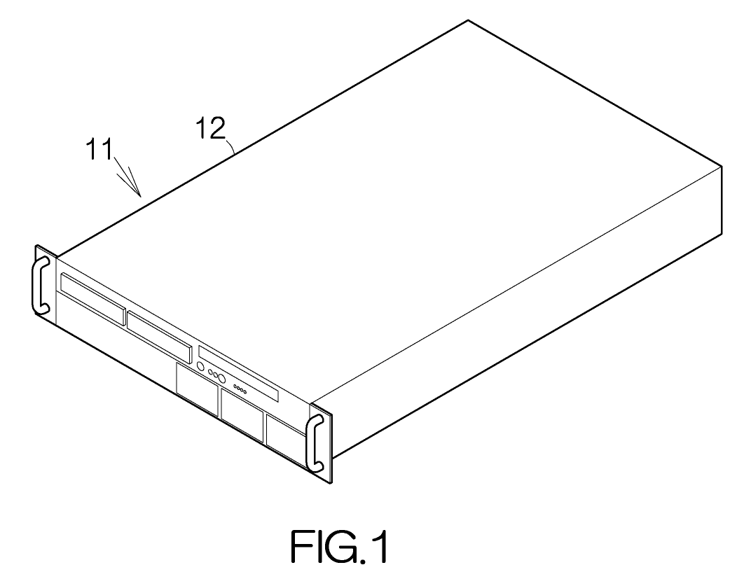

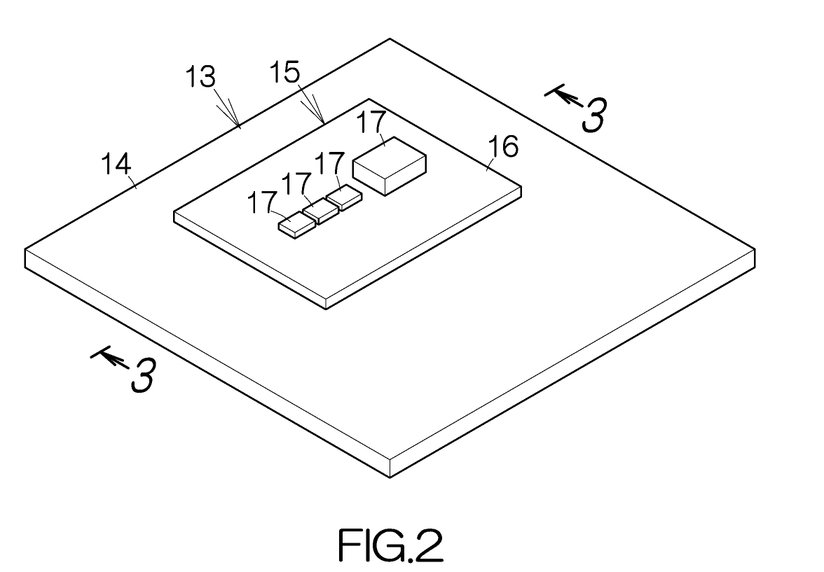

FIG. 1 schematically illustrates a server computer 11 as an example of an electronic apparatus. The server computer 11 is mounted on a rack, for example. The server computer 11 includes an enclosure 12. A printed wiring board unit or main board unit is enclosed in the enclosure 12. As shown in FIG. 2, the main board unit 13 includes a printed wiring board 14 made from a resin substrate, for example. An electronic component, namely a power supply module 15 is mounted on the surface of the printed wiring board 14. The power supply module 15 forms a so-called surface mount device (SMD). The power supply module 15 includes a resin substrate 16. Components 17 such as a capacitor, a transistor, a photocoupler and the like are mounted on the front and back surfaces of the resin substrate 16.

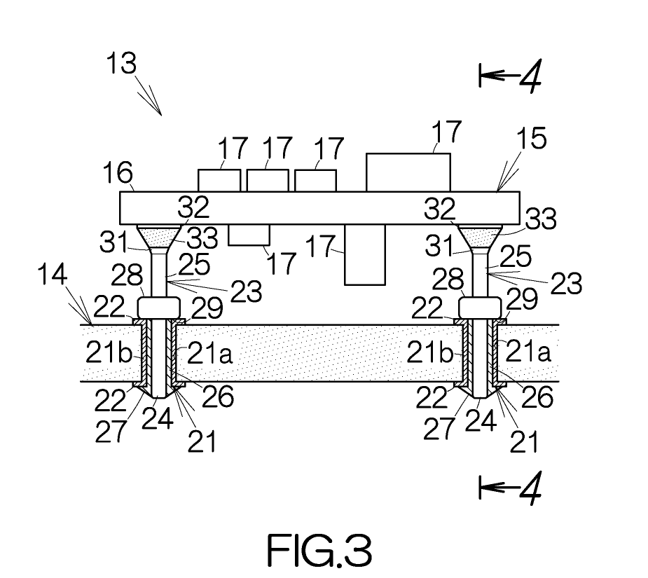

FIG. 3 schematically illustrates the main board unit 13 according to a first embodiment of the present invention. Through holes 21 are formed in the printed wiring board 14. The through holes 21 penetrate the printed wiring board 14 from its front surface to its back surface. The individual through hole 21 includes a through bore 21a extending through the printed wiring board 14 from the front surface to the back surface of the printed wiring board 14. A cylindrical metal wall 21b is formed in the through bore 21a. The cylindrical metal wall 21b is connected to land patterns 22 on the front and back surfaces of the printed wiring board 14. The cylindrical metal wall 21b and the land patterns 22 may be made of an electrically-conductive material such as copper, for example. The front and back surfaces of the printed wiring board 14 correspond to first and second surfaces or second and first surfaces, respectively. Here, the front surface corresponds to the first surface while the back surface corresponds to the second surface.

Electrically-conductive pins 23 are received in the corresponding through holes 21. The electrically-conductive pins 23 are arranged in a matrix between the printed wiring board 14 and the resin substrate 16, for example. The electrically-conductive pins 23 function as signal pins or ground pins, for example. The electrically-conductive pin 23 includes a first pin body 24 extending in the through hole 21 and a second pin body 25 standing upright from the front surface of the printed wiring board 14. The first pin body 24 and the second pin body are formed in a columnar shape, for example. The bottom end of the second pin body 25 is connected to the top end of the first pin body 24. The bottom end of the first pin body 24 protrudes out of the through hole 21 from the back surface of the printed wiring board 14. The individual through hole 21 is filled with an electrically-conductive material, namely solder 26. Solder consisting tin, silver and copper may be employed as the solder 26, for example. The solder 26 forms a fillet 27 at the bottom end of the first pin body 24. The fillet 27 serves to enhance the bonding strength between the metal wall 21b and the first pin body 24. The first pin body 24, the metal wall 21b and the land pattern 22 are electrically connected through the solder 26.

A flange 28 is formed at the bottom end of the second pin body 25. The flange 28 extends outward in the radial direction from the outer peripheral surface of the second pin body 25. The flange 28 is formed in an annular shape along the outer peripheral surface of the second pin body 25, for example. A stepped surface 29 is defined on the lower end of the flange 28. The stepped surface 29 extends outward from the outer peripheral surface of the first pin body 24 at the tip end of the first pin body 24. The stepped surface 29 extends along an imaginary plane perpendicular to the longitudinal axis of the second pin body 25. The stepped surface 29 of the flange 28 is received on the front surface of the printed wiring board 14, namely on the land pattern 22. A coned portion 31 is formed at the tip end of the second pin body 25. The diameter of the coned portion 31 gradually increases as the position gets closer to the tip end of the second pin body 25. The coned portion 31 is formed in the shape of an inverted frustum of a corn, for example. The generatrix of the cone portion 31 intersects with the longitudinal axis of the second pin body 25 at an inclination angle of 30 degrees, for example. Here, the first pin body 24, the second pin body 25 and the flange 28 may integrally be formed as a one-piece component, for example. Such a one-piece component may be made of an electrically-conductive material such as copper, nickel or the like, for example.

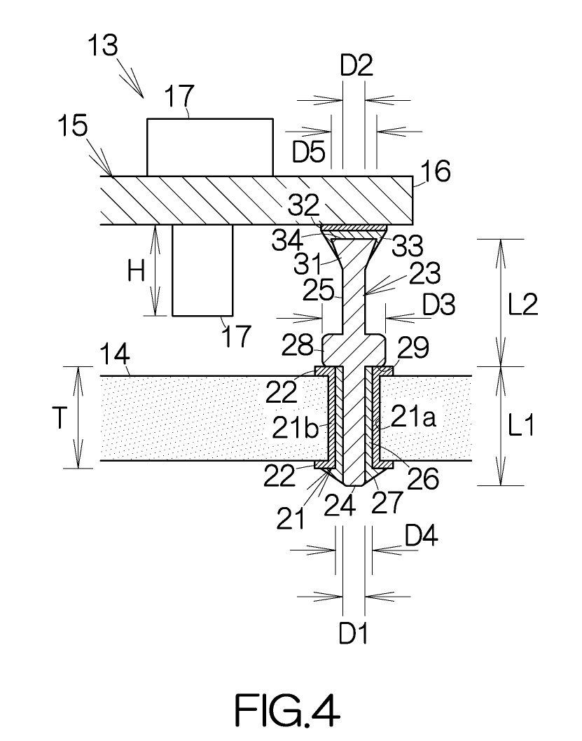

Electrically-conductive pads 32 are formed on the back surface of the resin substrate 16. The electrically-conductive pads 32 are received on the corresponding coned portions 31. Solder 33 is utilized to bond the electrically-conductive pads 32 to the corresponding coned portions 31. The electrically-conductive pads 32 are thus electrically connected to the coned portions 31 through the solder 33. Here, as shown in FIG. 4, the outer peripheral surface of the individual coned portion 31 is partially covered with the solder 33, for example. This results in enhancement of the bonding strength between the solder 33 and the coned portion 31. A receiving surface 34 is defined on the top end of the second pin body 25 namely the top end of the individual coned portion 31. The receiving surface 34 is formed in the shape of a circle, for example. The receiving surface 34 is a flat surface extending in parallel with the front surface of the printed wiring board 14. The solder 33 is interposed between the receiving surface 34 and the electrically-conductive pad 32. The solder 33 is received on the receiving surface 34. Solder consisting tin, silver and copper may be employed as the solder 33, for example.

As is apparent from FIG. 4, the first pin body 24 has a uniform diameter, namely a first diameter D1, from its bottom end to its top end. Likewise, the second pin body 25 has a uniform diameter, namely a second diameter D2, from its bottom end to the coned portion 31. Here, the first diameter D1 of the first pin body 24 is set equal to the second diameter D2 of the second pin body 25. The outer diameter D3 of the flange 28 is set larger than the second diameter D2 of the second pin body 25. The outer diameter D3 of the flange 28 is set larger than the inner diameter D4 of the through hole 21. The flange 28 thus closes the opening of the through hole 21 at the front surface of the printed wiring board 14. The diameter of the coned portion 31 gradually increases from the second diameter D2 as the position gets closer to the top end of the coned portion 31. The maximum diameter D5 of the coned portion 31 is thus set larger than the second diameter D2 of the second pin body 25. The second diameter D2 is set smaller than the outer diameter D3 and the maximum diameter D5. The electrically-conductive pin 23 is in this manner prevented from an increase in the volume.

The length L1 of the first pin body 24 from its bottom end to its top end is set larger than the thickness T of the printed wiring board 14. The thickness T is set at 2 mm approximately, for example. The first pin body 24 thus reliably protrudes out of the through hole 21 from the back surface of the printed wiring board 14. The length L2 of the second pin body 25 from its bottom end to its top end is set larger than the maximum height H of the components 17 from the back surface of the resin substrate 16. Even when the power supply module is mounted on the printed wiring board 14, the printed wiring board 14 is reliably prevented from contact or collision with the components 17. A difference may be minimized between the length L2 and the maximum height H. The electrically-conductive pin 23 is in this manner prevented from an increase in the volume.

Next, description will be made on a method of making the main board unit 13. The printed wiring board 14 is first prepared. The through holes 21 have already been formed in the printed wiring board 14. As shown in FIG. 5, the first pin body 24 of the individual electrically-conductive pin 23 is inserted into the corresponding through hole 21 from the front surface of the printed wiring board 14. The bottom end of the first pin body 24 protrudes out of the through hole 21 from the back surface of the printed wiring board 14. The stepped surface 29 of the flange 28 is received on the land pattern 22 on the front surface of the printed wiring board 14. The stepped surface 29 closes the opening of the through hole 21 at the front surface of the printed wiring board 14. The flange 28 allows the second pin body 25 to stand upright from the front surface of the printed wiring board 14. The flange 28 simultaneously serves to reliably prevent the electrically-conductive pin 23 from sinking into the through hole 21 and falling off the back surface of the printed wiring board 14.

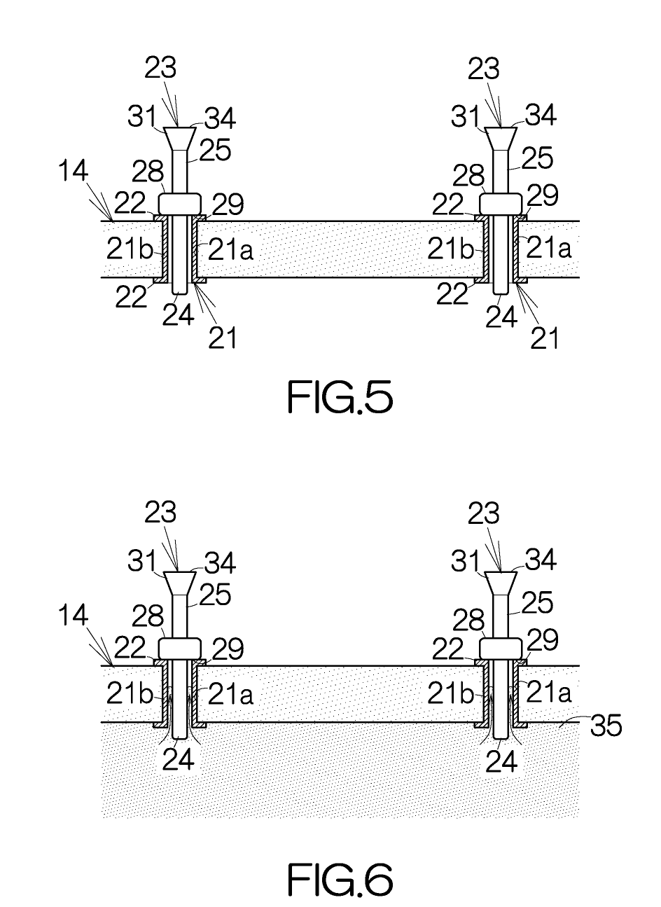

As shown in FIG. 6, the back surface of the printed wiring board 14 is immersed in a molten solder 35 in a solder bath. The capillary action inside the through hole 21 allows the molten solder 35 to penetrate into the through holes 21 from the back surface of the printed wiring board 14. The heat of the molten solder 35 is transferred to the electrically-conductive pins 23 because of a contact between the electrically-conductive pins 23 and the molten solder 35. The temperature of the electrically-conductive pins 23 sufficiently increases. An increased temperature of the electrically-conducive pins 23 serves to promote the penetration of the molten solder 35 into the through holes 21. The molten solder 35 is thus allowed to reach the stepped surfaces 29 of the flanges 28. The through holes 21 are entirely filled with the molten solder 35. The printed wiring board 14 is taken out of the solder bath after a predetermined duration of time is elapsed. The molten solder is then cooled down. The molten solder 35 gets cured or hardened. The through holes 21 are in this manner filled with the solder 26. The individual electrically-conductive pin 23 is bonded to the corresponding through hole 21. The fillet 27 is formed at the bottom end of the second pin body 25.

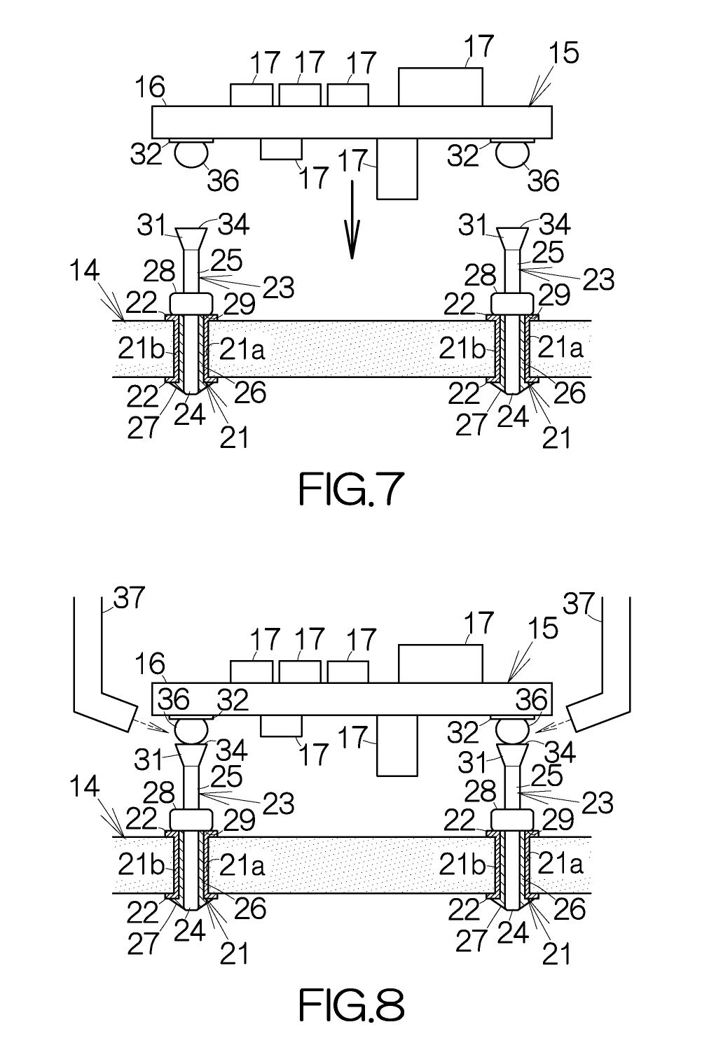

The power supply module 15 is subsequently prepared as shown in FIG. 7. A solder ball 36 has already been attached to the individual electrically-conductive pad 32 of the resin substrate 16 of the power supply module 15. The power supply module 15 is received on the receiving surfaces 34 of the electrically-conductive pins 23 through the solder balls 36. Since the receiving surfaces 34 are defined on the top ends of the coned portions 31, it is relatively easy to position the power supply module 15 to the receiving surfaces 34. When the power supply module 15 is received on the receiving surfaces 34, the discharge openings of heating nozzles 37 of a heating apparatus, not shown, are opposed to the solder balls 36, as shown in FIG. 8. Hot air is discharged against the solder balls 36 through the discharge openings of the heating nozzles 37. The temperature of the hot air is set equal to or higher than the melting point of the solder balls 36. The hot air thus makes the solder balls 36 melt. The weight of the power supply module makes the solder balls 36 spread on the receiving surfaces 34. The solder balls 36 spread all over the corresponding receiving surfaces 34. When discharge of the hot air is stopped, the solder balls 36 are cooled down. The solder balls 36 get hardened or cured. The power supply module 15 is thus bonded to the top ends of the electrically-conductive pins 23 through the solder 33. The power supply module 15 is in this manner mounted on the printed wiring board 14. The main board unit 13 is produced.

In the method, the electrically-conductive pins 23 are solely inserted into the corresponding through holes 21 of the printed wiring board 14. In this case, the power supply module is not bonded to the top ends of the electrically-conductive pins 23. It is thus extremely easy to insert the electrically-conductive pins 23 into the corresponding through holes 21. The power supply module 15 is mounted on the tip ends of the inserted electrically-conductive pins 23. As compared with the case where the electrically-conductive pins are first bonded to the power supply module, an operator is released from a troublesome operation of inserting the electrically-conductive pins into the corresponding through holes 21. The power supply module 15 can be mounted with efficiency.

In addition, when the printed wiring board 14 is immersed in the molten solder 35, the electrically-conductive pins 23 are solely inserted in the corresponding through holes 21 of the printed wiring board 14. The heat capacity of the electrically-conductive pins is thus significantly smaller than the total heat capacity of the electrically-conductive pins and the power supply module. When heat is transferred to the electrically-conductive pins 23 from the molten solder 35, heat tends to stay in the electrically-conductive pins 23. The temperature of the electrically-conductive pins 23 can thus be kept sufficiently high. The molten solder 35 is allowed to smoothly flow upward along the electrically-conductive pins 23. Even if the thickness T of the printed wiring board 14 is relatively large, the penetration of the molten solder 35 into the through holes 21 can reliably be achieved. The electrically-conductive pins 23 are reliably bonded to the corresponding through holes 21 through the solder 26.

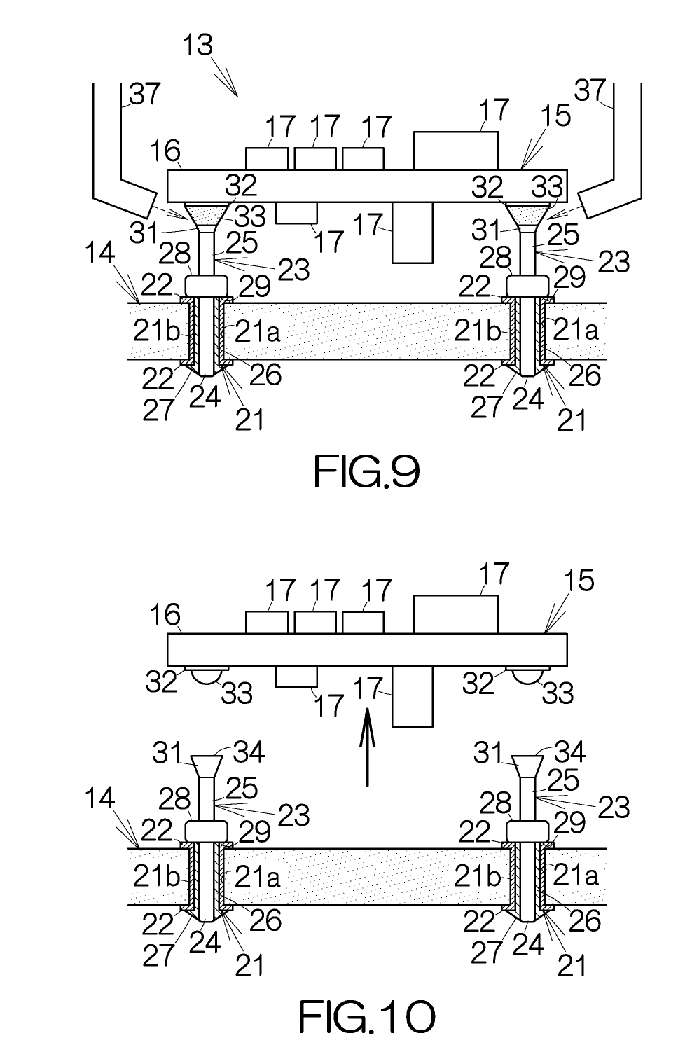

In the main board unit 13, in the case where the power supply module 15 malfunctions, for example, the power supply module 15 is preferably replaced with a new one. The openings of the aforementioned heating nozzles 37 are opposed to the solder 33 for replacement of the power supply module 15, as shown in FIG. 9. Hot air is discharged against the solder 33. The temperature of the hot air is set equal to or higher than the solder 33. The hot air makes the solder 33 melt. The power supply module 15 can thus be lifted up from the tip ends of the electrically-conductive pins 23 or receiving surfaces 34, as shown in FIG. 10. The power supply module 15 can be removed from the printed wiring board 14. The molten solder 33 remains on the electrically-conductive pads 32 and the receiving surfaces 34.

A new power supply module 15 is then prepared. The solder balls 36 have already been attached to the electrically-conductive pads 32 of the resin substrate 16 in the new power supply module 15. The solder balls 36 are set on the receiving surfaces 34 of the corresponding electrically-conductive pins 32. Hot air is discharged against the solder balls 36 through the heating nozzles 37. The hot air makes the solder balls 36 melt. The weight of the power supply module 15 makes the solder balls 36 spread on the receiving surfaces 34 in the same manner as described above. When discharge of the hot air is stopped, the solder balls 36 are cooled down. The solder balls 36 get hardened or cured. The power supply module 15 is thus bonded to the top ends of the electrically-conductive pins 23 through the solder 33. Replacement of the power supply module 15 is completed.

In such a method of removing the power supply module 15, the solder 33 melts between the power supply module 15 and the electrically-conductive pins 23. The power supply module 15 can thus be removed from the top ends of the electrically-conductive pins 23, leaving the electrically-conductive pins 23 on the printed wiring board 14. The molten solder 33 is received on the receiving surfaces 34 or top ends of the second pin bodies 25. The first pin bodies 24 are thus prevented from receiving heat transfer from the second pin bodies 25. The solder 26 is prevented from melting in the through holes 21. The electrically-conductive pins 23 are kept bonded to the printing wiring board 14. The process of replacing the power supply module 15 is simplified.

In a conventional power supply module, the electrically-conductive pins are fixed to the resin substrate. It is thus required to immerse the back surface of the printed wiring board in a molten solder in a solder bath for replacement of the power supply module. The solder melts in the through holes. The electrically-conductive pins are removed from the through holes, namely the printed wiring board, along with the power supply module. Suction is utilized to remove the solder from the through holes, for example. The electrically-conductive pins of a new power supply module are then inserted into the corresponding throughholes. The through holes are filled with the molten solder in the solder bath.

In such a conventional method, when the thickness of the printed wiring board is relatively large, for example, it is impossible to sufficiently melt the solder in the through holes. Removal of the electrically-conductive pins from the through holes is thus hindered. Repeated cycles of melt and solidification of the solder makes the metal walls of the through holes melt. In addition, the suction cannot contribute to a complete or sufficient removal of the solder from the through holes. If the hardened or cured solder remains in the through holes, it is required to clear the through holes by removing the solder out of the through holes with a drill driven into the through holes. The metal walls of the through holes can thus be damaged. This results in disconnection of wiring in the printed wiring board.

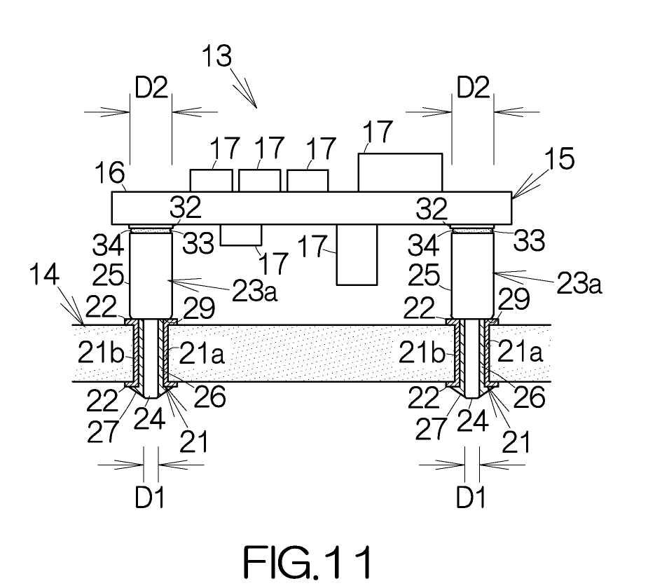

As shown in FIG. 11, an electrically-conductive pin 23a may be incorporated in the main board unit 13 in place of the aforementioned electrically-conductive pin 23. The second pin body 25 has the second diameter D2 larger than the first diameter D1 of the first pin body 24 in the electrically-conductive pin 23a. The diameter of the second pin body 25 is set constant from its bottom end to its top end. Here, the second diameter D2 is set equal to the outer diameter D4 of the aforementioned flange 28. The aforementioned stepped surface 29 is thus defined in the bottom end of the second pin body 25. The aforementioned receiving surface 34 is defined at the top end of the second pin body 25. The electrically-conductive pin 23a are allowed to enjoy the aforementioned advantages. Like reference numerals are attached to the structure or components equivalent to those of the aforementioned first electrically-conductive pin 23.

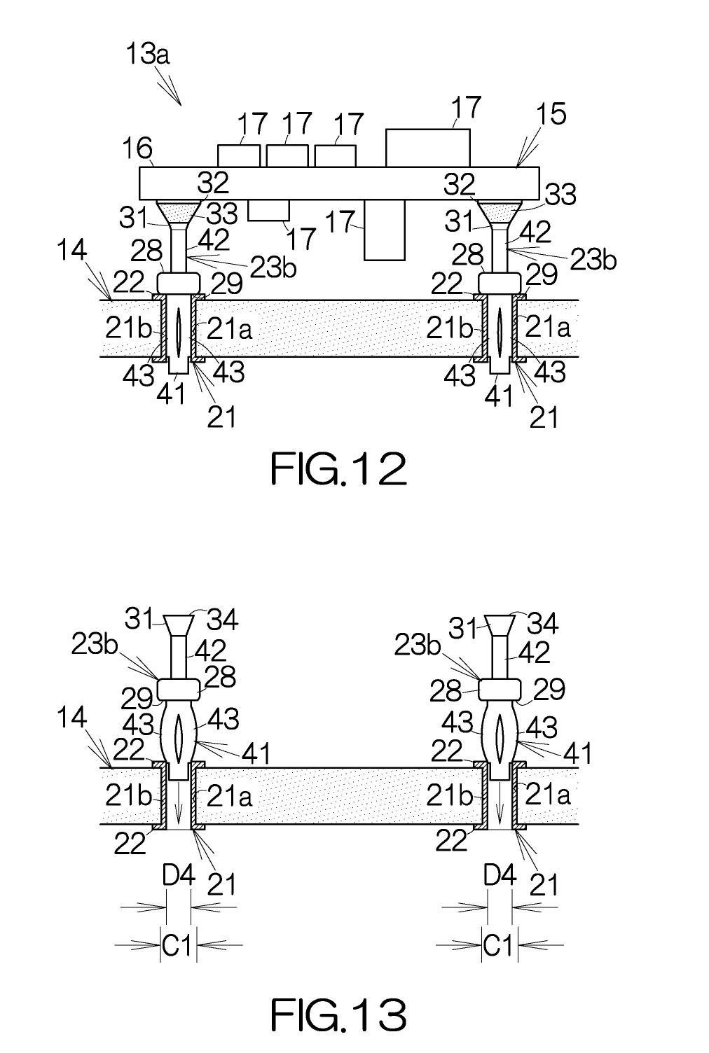

FIG. 12 schematically illustrates the structure of a main board unit 13a according to a second embodiment of the present invention. An electrically-conductive pin 23b is incorporated in the main board unit 13a in place of the aforementioned electrically-conductive pins 23, 23a. The electrically-conductive pin 23b forms a so-called press-fit pin. The electrically-conductive pin 23b includes a press-fit portion 41 and a pin body 42. The press-fit portion 41 is received in the through hole 21. The pin body 42 is designed to stand upright from the front surface of the printed wiring board 14. The bottom end of the pin body 42 is connected to the top end of the press-fit portion 41. The power supply module 15 is bonded to the top end of the pin body 41, namely the top end of the electrically-conductive pin 23b, through the solder 33.

The pin body 42 has a structure identical to that of the second pin body 25 of the aforementioned electrically-conductive pin 23. The diameter of the second pin body 42 may be set equal to the second diameter D2 of the second pin body 25 of the electrically-conductive pin 23. The aforementioned flange 28 is formed at the bottom end of the pin body 42. The aforementioned stepped surface 29 on the flange 28 extends outward in the radial direction from the outer peripheral surface of the press-fit portion 41 at the top end of the press-fit portion 41. The electrically-conductive pin 23b is received on the land pattern 22 at the stepped surface 29. The aforementioned coned portion 31 is formed at the top end of the pin body 42. The diameter of the coned portion 31 gradually increases as the position gets closer to the top end of the pin body 42. Here, the press-fit portion 41, the pin body 42 and the flange 28 may be integrally formed as a one-piece component, for example. Such a one-piece component may be made of an electrically-conductive material such as copper, nickel or the like.

The press-fit portion 41 includes a pair of elastically-deformable pieces 43, 43 extending side by side from the bottom end of the pin body 42 along the longitudinal axis of the electrically-conductive pin 23b. The elastically-deformable pieces 43, 43 are coupled to each other at their bottom ends. The contour of the elastically-deformable pieces 43, 43 is set larger than the inner diameter D4 of the through hole 21. The press-fit portion 41 exhibits an elastic force in the through hole 21, based on the action of the elastically-deformable pieces 43, 43, in a direction outward from the longitudinal axis of the electrically-conductive pin 23b. The elastically-deformable pieces 43 are thus urged against the through hole 21, namely the inner surface of the metal wall 21b. The press-fit portion 41 is thus elastically held in the through hole 21. Like reference numerals are attached to the structure or components equivalent to the aforementioned main board unit 13. The main board unit 13a is allowed to enjoy the aforementioned advantages.

In the process of making the main board unit 13a, as shown in FIG. 13, the press-fit portion 41 of the individual electrically-conductive pin 23b is inserted into the corresponding through hole 21 from the front surface of the printed wiring board 14. Since the contour C1 of the elastically-deformable pieces 43, 43 is set larger than the inner diameter D4 of the through hole 21, the elastically-deformable pieces 43, 43 are elastically deformed toward the longitudinal or central axis of the electrically-conductive pin 23b. An elastic force acts on the inner surface of the metal wall 21b based on the elastic deformation of the elastically-deformable pieces 43, 43. The press-fit portion 41 is thus elastically held in the through hole 21. Soldering is omitted from the process of mounting the elastically-conductive pin 23b. The top end of the elastically-conductive pin 23b is bonded to the corresponding electrically-conductive pad 32 through the solder ball 36 in the same manner as described above. The main board unit 13a is in this manner produced.

What is claimed is:

1. A method of making a printed wiring board unit, comprising:
inserting an electrically-conductive pin into a through hole penetrating through a substrate between a first surface and a second surface defined at a reverse side of the first surface so that the electrically-conductive pin stands upright from the first surface of the substrate; and
mounting an electronic component on a tip end of the electrically-conductive pin standing upright from the first surface.

2. The method according to claim 1, wherein a solder ball is utilized to bond the electronic component to the tip end of the electrically-conductive pin.

3. The method according to claim 1, wherein the electrically-conductive pin protrudes out of the through hole from the second surface of the substrate when the electrically-conductive pin is inserted into the through hole, the method further comprising immersing the second surface of the substrate in a molten solder in a solder bath.

4. A printed wiring board unit comprising:
a substrate defining a through hole penetrating through the substrate from a first surface to a second surface defined at a reverse side of the first surface;
an electrically-conductive pin received in the through hole, the electrically-conductive pin standing upright from the first surface of the substrate;
a solder received on a tip end of the electrically-conductive pin protruding from the first surface of the substrate; and
an electronic component bonded to the tip end of the electrically-conductive pin through the solder.

5. The printed wiring board unit according to claim 4, further comprising a fillet formed at a tip end of the electrically-conductive pin, the tip end protruding out of the through hole from the second surface of the substrate.

6. The printed wiring board unit according to claim 5, wherein the electrically-conductive pin includes:
a first pin body extending in the through hole;
a second pin body connected to a tip end of the first pin body, the second pin body standing upright from the first surface of the substrate; and
a stepped surface extending outward from an outer peripheral surface of the first pin body, the stepped surface received on the first surface of the substrate.

7. The printed wiring board unit according to claim 6, wherein the stepped surface is defined on a flange extending outward from an outer peripheral surface of the second pin body.

8. The printed wiring board unit according to claim 6, wherein the stepped surface is defined on the second pin body having a second diameter larger than a first diameter of the first pin body.

9. The printed wiring board unit according to claim 4, wherein the electrically-conductive pin includes:
a pin body having a constant diameter, the pin body protruding out of the through hole from the first surface of the substrate; and
a coned portion formed at a tip end of the pin body, the coned portion expanding from the tip end of the pin body to a receiving surface for receiving the solder.

10. The printed wiring board unit according to claim 4, wherein the electrically-conductive pin includes:
a press-fit portion elastically held in the through hole; and
a pin body extending from the press-fit portion, the pin body standing upright from the first surface of the substrate.
